(19) United States
(12) Patent Application Publication
(10) Pub. No.: US 2025/0270674 A1
(43) Pub. Date: Aug. 28, 2025

(54) PROCESS TO OBTAIN LITHIUM SULFATE MONOHYDRATE ORE WITH LOW CONTENTS OF IMPURITIES ASSOCIATED TO CHLORINE AND MAGNESIUM

(71) Applicant: SOCIEDAD QUIMICA Y MINERA DE CHILE S.A., Santiago (CL)

(72) Inventor: Osvaldo YAÑEZ, Santiago (CL)

(73) Assignee: SOCIEDAD QUIMICA Y MINERA DE CHILE S.A., Santiago (CL)

(21) Appl. No.: 18/862,253

(22) PCT Filed: May 2, 2022
(86) PCT No.: PCT/CL2022/050046

§ 371 Date: Nov. 1, 2024

(51) Int. Cl. C22B 26/12; C22B 1/24; C22B 3/22

(52) U.S. Cl. CPC C22B 26/12; C22B 1/24; C22B 3/22

(57) ABSTRACT

This patent application refers to a process to obtain lithium sulfate monohydrate ore with low contents of impurities associated to chlorine and magnesium; in particular, the process consists of the concentration, through grinding, flotation, and filtration stages, of the lithium sulfate present in potassium Carnallite (KCl*MgCl2*6H20) stockpiles with high contents of lithium sulfate (Li2S04*H20) and sodium chloride (NaCl).

### PRIOR ART

Far years, high sulfate brine has only served as a potassium producer, and the Lithium content has been returned to the salt flat through reinjection. This means that not all the extracted brine produces Lithium, even though it also has an important composition of this ion. Currently, practically all the brine extracted from the salt flat produces Potassium.

Lithium production contemplates 2 deposits, one where the predominant anion is Chlorine and another one that has a large amount of Sulfate. This difference is important because the production and/or refining process changes depending on the raw material.

Given the above, the processes that exist in the prior art are mainly focused on processes to produce lithium carbonate (Li2C03) and, to a lesser extent, lithium hydroxide (LiOH.H20), from the first deposit; this is based on Chlorine and uses very little Sulfate. However, a technically viable alternative of processing high Sulfate brines was not available, until now.

In the prior art, it is possible to find varied information for obtaining lithium salts. However, all of such information is significantly different from the process of the invention.

Chinese patent publication CN102921553 (A) describes a method far the flotation of Lithium Potassium Sulfate in a mixture with Sodium Chloride. The product floated in this application is Lithium Sulfate, which is a mineral species different from Lithium Potassium Sulfate. Furthermore, in this application, Lithium Sulfate is originally mixed with a number of minerals besides Sodium Chloride, such as Carnallite (hydrated Potassium Magnesium Chloride), Bischofite (hydrated Magnesium Chloride) and other contaminants which are also present, making the process more complex.

Chinese patent publication CN101318670 (A) describes a production process for extracting Lithium Chloride salt from a salt mixture containing Lithium Chloride salt and Bischofite (hydrated Magnesium Chloride) produced from brine that is evaporated in evaporation ponds. Although in both processes the mixture of salts before flotation is obtained by evaporation of brines in evaporation ponds, the salts obtained are different both in terms of the salt to be floated, since in the case of this application the salt is Lithium Sulfate and that of patent CN101318670 is Lithium Chloride, and in terms of the salts present in the mixture, since in addition to Bischofite, in this application, Sodium Chloride, Carnallite (Potassium Chloride and hydrated Magnesium Chloride) and other contaminants are also present.

Chinese patent publication CN109174438 (A) describes a classification process of spodumene ore beneficiation and belongs to the technical field of multi-metal beneficiation. Although spodumene flotation can be part of a process that generates Lithium Sulfate as an intermediate product, spodumene is a lithium aluminosilicate derived from a mixture of rocks and not from brines, which makes the raw material to be floated completely different from the one used in this application.

Thus, it is possible to assert that this invention salves a problem for which no solution previously existed, since it manages to concentrate lithium sulfate monohydrate with low contents of impurities associated to chlorine and magnesium from brines which used to be financially unattractive for purposes of exploiting the same far the production of lithium.

### BRIEF DESCRIPTION OF THE FIGURE

FIG. 1: depiction of a diagram of the invention's general lithium sulfate monohydrate concentration process.

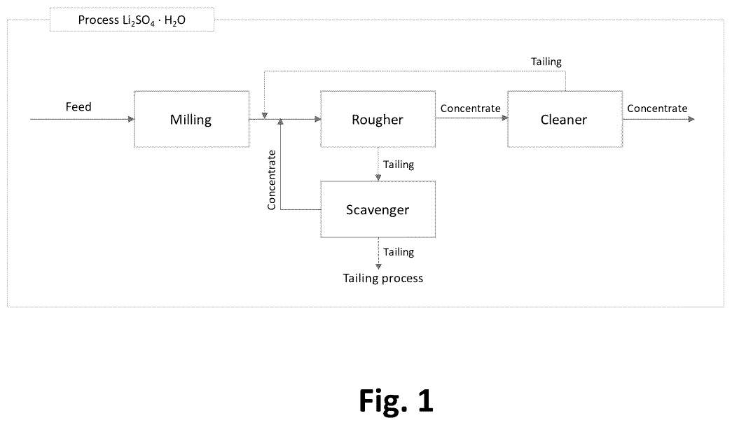

### DETAILED DESCRIPTION OF THE INVENTION

The process to obtain lithium sulfate monohydrate ore with low impurity contents associated with chlorine and (Li2S04.H20) magnesium involves 2 main stages; grinding and flotation.

This process consists of feeding potassium carnallite salts with high SO4 concentration to a comminution stage, specifically grinding. The purpose of this is to reduce its size and release the lithium sulfate present in the mineral. This material enters a Rougher flotation stage, which aims to recover much material of interest as possible, prioritizing recovery over ore grade. The generated concentrate enters a Cleaner flotation stage, which aims to increase the grade until achieving the required purity, in order to be fed into a subsequent stage. This selective stage favors the grade of the mineral of interest over the recovery. The generated tailings are recirculated to the rougher flotation in order to recover the material that was not floated in the circuit.

The Rougher tailings that are generated enter a second recovery stage, which consists of a Scavenger flotation, the purpose of which is to increase the overall recovery of the flotation circuit, recovering the mineral that could not be floated in the previous stage, and obtaining tailings exhausted in lithium sulfate with a grade of 0.2% Li. The concentrate obtained is characterized by being of low grade, so it can be recirculated to the Rougher Flotation.

The range of Lithium Sulfate feed that has been validated is in the order of 4-30% Lithium Sulfate monohydrate, with 50-70% of potassium Carnallite, 8-17% of sodium chloride; in some cases bischofite (MgCl2*6H2O) can be found in ranges of 4-20%, the remaining being mainly impurities associated with boron (1-2%) and calcium (0.1-0.2%).

The grinding of the material is carried out in a collapse crusher and cage mill, with the objective of releasing the lithium sulfate crystals present in the potassium carnallite matrix and preparing them for flotation. To avoid overstressing the mill, previously saturated and balanced brine is added to the mill shells, thus removing possible solids embedded therein.

After the grinding stage, the salt comes into contact with the brine previously saturated and balanced with the same salt, thereby generating a pulp with a high percentage of solids (40-50%), where 50% of flotation reagent (amine collector) is added to prepare the material far the flotation stage and thus pump the pulp to the Rougher flotation cells.

The recirculation flow of the cleaner tailings and Scavenger concentrate are added to the rougher flotation cell; these flows have a low percentage of solids. As a result, a pulp of approximately 30-35% solids are generated as feed to the Rougher flotation, and the remaining 30% of the collector and frothier is added to the cell.

The Rougher flotation operates in a recuperative way, obtaining lithium sulfate monohydrate concentrates above 50%. The Rougher flotation tailings, with low lithium sulfate monohydrate content, go through a classification and regrinding stage in cage mills.

The reground and small size material from the classification is pooled together to become the feed to the Scavenger flotation stage, together with the remaining percentage of collector and frothier, the objective of which is to generate plant tailings with the lowest levels of lithium sulfate, with the cell working in a recuperative way.

On the other hand, the Rougher concentrate obtained is taken to the cleaning stage (Cleaner), where it must be concentrated to levels of 85% lithium Sulfate, working the cells selectively to increase the height of the cushion. Given that this is a selective flotation, the tailings of this phase are recirculated to the Rougher flotation mentioned above in order to avoid losses.

The Cleaner concentrate is sent to a filtration stage, where a pile with a high content of lithium sulfate >85% is obtained, and it is there where the pile is washed with sprinklers using hot water, the objective of which is to solubilize the impurities associated with chlorine and increase the grade of the product, thus obtaining grades higher than 90%.

### EXAMPLE

According to the industrial test conducted to the process to obtain monohydrate lithium Sulfate via flotation, the following results were obtained.

TABLE 1
Líthíum Sulfate content in prímary flows.

| | Li2SO4*H2O |
|---|---|
| Flow | [%] |
| Feeding | 18.99 |
| Product | 90.67 |

TABLE 2
Chemícal composítíon of prímary flows.

| | K | Na | Mg | Ca | S04 | Li | Cl | H3803 | Ins |
|---|---|---|---|---|---|---|---|---|---|
| Flow | [%] | [%] | [%] | [%] | [%] | [%] | [%] | [%] | [%] |
| Feed- | 7.73 | 4.17 | 6.30 | 0.03 | 14.37 | 2.06 | 32.17 | 0.66 | 0.05 |
| ing | | | | | | | | | |
| Prod- | 1.20 | 0.20 | 1.17 | 0.04 | 69.19 | 9.84 | 4.08 | 1.16 | 0.35 |
| uct | | | | | | | | | |

Additionally, tests were conducted at a laboratory scale, where the lithium sulfate concentration process was used and validated, via flotation, using the 5-liter Denver flotation cell.

The Lithium Sulfate feeder range that has been validated at a laboratory scale is of the order of 5-30% monohydrated Lithium Sulfate, with 50-70% of potassium Carnallite, 8-17% sodium chloride, in some cases bischofite (MgCl2*6H2O) is present in ranges of 5-2%, with the remainder being mainly impurities associated to boron (1-2%) and calcium (0.1-0.2%). After the grinding, the homogeneous loads of the milled material are generated, in accordance with the cell's capacity.

It is relevant to highlight that, because we are dealing with salts, it is necessary to create a brine that is saturated and at balance with this salt, in order to avoid dissolutions and/or precipitations of undesired varieties.

Regarding the Rougher flotation, a pulp is formed with 50% of solids, which is conditioned during 10 minutes by shaking it in the flotation cell with the flotation reagents (amine collector and frothier). Once this conditioning time has expired, the remaining brine is added in order to achieve the percentage of solids sought far the stage; in this case, the process works at 31% of solids, the air is released, and the parameters are adjusted as indicated above.

When the first drop of the concentrate falls onto the tray, the flotation time begins. Far the Rougher flotation, this time was set at 7 minutes. The concentrate is padded every 15 seconds, and the brine is repositioned in order to maintain the cell's level via a peristaltic pump.

Once the flotation time has ended, the air valve is closed and the shaking is halted, the obtained flows are kneaded and filtered, in order to obtain the solid product and tailings, which must also be needed in order to generate a new pulp to feed the Cleaner flotation.

In the Cleaner flotation, the same 5-liter cell is used, and the procedure is repeated, conditioning during 10 minutes at 50% of solids, adding collector and the frothier and, once the conditioning has concluded, it is refilled until completing 20% of feeding solids and the air is released. Justas in the Rougher flotation, the flotation time begins once the first drop of concentrate falls through the cell's wall. The time set far this flotation is 10 minutes. The obtained concentrate material is then filtered and disposed of far subsequent stages.

Below, we present the main results obtained from the stages constituting the process to obtain lithium sulfate monohydrate, ata laboratory scale.

TABLE 3
Chemíeal eomposítíon of Rougher feedíng
and Cleaner eoneentrate of líthíum Sulfate, laboratory sea/e.

| | K | Na | Mg | Ca | SO4 | Li | Cl | H3BO3 |
|---|---|---|---|---|---|---|---|---|
| Flow | [%] | [%] | [%] | [%] | [%] | [%] | [%] | [%] |
| Rougher | 9.00 | 4.64 | 6.13 | 0.01 | 14.01 | 2.08 | 34.56 | 0.14 |
| Feeding | | | | | | | | |
| Cleaner | 0.73 | 1.44 | 1.36 | 0.04 | 66.81 | 9.54 | 6.82 | 3.43 |
| Concentrate | | | | | | | | |

TABLE 4
Líthíum Sulfate eontent of Rougher
feedíng and Cleaner eoneentrate, laboratory sea/e

| Flow | Li2SO4*H2O [%] |
|---|---|
| Rougher Feeding | 19.16 |
| Cleaner Concentrate | 87.96 |

1. Process to obtain lithium sulfate monohydrate ore with low
contents of impurities associated to chlorine and magnesium, from brines which were not financially attractive, in order to exploit them far the production of Lithium, CHARACTERIZED by feeding potassium carnallite salts
with a highconcentration of S04 are fed to comminution stage, specifically grinding, in arder to reduce their size and release the lithium sulfate present in the ore; in which the
material obtained from the grinding is subjected to a Rougher flotation stage, the purpose of which is to recover the highest quantity of material of interest as possible, favoring recovery over the mineral's grade; where the concentrate that is generated in the Rougher flotation stage enters a Cleaner flotation stage or a cleaning stage, the purpose of which is to increase the grade until achieving the required purity, in arder to be fed to a subsequent stage; in which tailings are generated in said Cleaner flotation, which are recirculated to said Rougher flotation, in arder to recover the material that was not floated in the circuit; in which said Rougher flotation generates tailings that are inserted into a second recuperative stage, which consists of a Scavenger flotation, the purpose of which is to increase the overall recovery of the flotation circuit, recovering the material which could not float during the previous stage, obtaining tailings exhausted in lithium sulfate with a grade of 0.2% Li.

2. Process to obtain lithium sulfate monohydrate ore with low contents of impurities, in accordance with claim 1,
CHARACTERIZED because said grinding of the material is carried out in a collapse crusher and cage mills, with the objective of releasing the lithium sulfate crystals present in said potassium carnallite matrix and preparing them far said Rougher flotation.

3. Process to obtain lithium sulfate monohydrate ore with low contents of impurities, in accordance with claim 2,
CHARACTERIZED because a previously saturated and balanced brine is added to the mill shells of the cage mill, removing possible solids embedded therein.

4. Process to obtain lithium sulfate monohydrate ore with low contents of impurities, in accordance with claim 1,
CHARACTERIZED because, after said grinding stage, said salts come into contact with a brine previously saturated and balanced with the same salts, generating a pulp with a high percentage of solids (40-50%), where 50% of flotation reagent (amine collector) is added to condition the obtained material.

5. Process to obtain lithium sulfate monohydrate ore with low contents of impurities, in accordance with claim 1,
CHARACTERIZED because the recirculation flow of the tailings from the Cleaner flotation stage and Scavenger flotation concentrate are added to the Rougher flotation, thus generating a pulp of approximately 30-35% solids to feed the Rougher flotation. Also, the remaining 30% of the collector and frother is added to a cell where said Rougher flotation is carried out.

6. Process to obtain lithium sulfate monohydrate ore with low contents of impurities, in accordance with claim 1,
CHARACTERIZED because said Rougher flotation operates in a recuperative way, obtaining lithium sulfate monohydrates above 50%, in which the Rougher flotation tailings, with low sulfate monohydrate contents, go through a classification and regrinding stage in cage mills.

7. Process to obtain lithium sulfate monohydrate ore with low contents of impurities, in accordance with claim 6,
CHARACTERIZED because the reground and small size material extracted from said classification is pooled together to become the feed to the Scavenger flotation stage, along with the remaining percentage of collector and frother, where plant tailings are generated with the lowest levels of lithium sulfate.

8. Process to obtain lithium sulfate monohydrate ore with low contents of impurities, in accordance with claim 1,
CHARACTERIZED be cause the obtained Rougher concentrate, which is subjected to said Cleaner flotation stage, is concentrated to levels of 85% lithium Sulfate.

9. Process to obtain lithium sulfate monohydrate ore with low contents of impurities, in accordance with claim 8,
CHARACTERIZED because the material obtained from the Cleaner flotation stage is subjected to a filtration stage, where a pile with a high content of lithium sulfate <85% is obtained.

10. Process to obtain lithium sulfate monohydrate ore with low contents of impurities, in accordance with claim 9,
CHARACTERIZED because said pile is subjected to washing with sprinklers, using hot water, where the impurities associated to chlorine are solubilized, and the product's grade is increased, achieving grades higher than 90%.
